(19) United States
(12) Patent Application Publication
(10) Pub. No.: US 2004/0145810 A1
(43) Pub. Date: Jul. 29, 2004

(54) Method and apparatus for realizing an optical filter with an arbitrary narrow band impulse response

(76) Inventor: Eliseo R. Ranalli, Irvine, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 10/724,551

(22) Filed: Nov. 28, 2003

Related U.S. Application Data
(60) Provisional application No. 60/441,701, filed on Jan. 23, 2003.

(51) Int. Cl. G02B 5/18

(52) U.S. Cl. 359/569; 359/575

(57) ABSTRACT

A filter synthesis technique for realizing an arbitrary (amplitude- and phase-specified) transfer function for narrow-band incident optical signals, using a quasi-periodic echelle structure. In an ordinary (periodic) diffraction grating, the fixed spacing of its rulings is chosen in order that the device exhibit a very narrow spectral peak at a particular center wavelength, for a given angle of incidence, when the output is observed at the appropriate diffraction angle. In accordance with the present invention, the basic periodic structure is spatially perturbed in both the center spacing and width of its rulings in such a manner as to spread the spectral peak into an arbitrary spectral shape in the vicinity of what was (in the original, unperturbed grating) a narrow peak. In addition, the phase transfer function over the spectral range of interest may be tailored to fit any desired spectral phase profile.

### CROSS-RELATED APPLICATIONS

This application claims priority from Provisional Patent Application Serial No. 60/441,701 filed Jan. 23, 2003

### BACKGROUND OF THE INVENTION

1. Field of the Invention

The present invention relates specifically to the field of passive optical filters. In particular, the invention relates to temporal (as opposed to spatial) filtering of narrow-band optical signals, as may be encountered in such fields as fiber optic communications, short pulse formation and analysis, optical spectroscopy and its related applications, such as chemical sensor technology. It provides a convenient means of realizing a high-order temporal matched filter with extraordinary spectral amplitude and phase acuity. As with ordinary ruled gratings, devices may be replicated from a master. Hence, this technique lends itself to mass production methods. Finally, and more generally, this technique may be applied to any wave phenomenon (e.g. radio waves and sound) for realizing a desired narrow-band temporal impulse response.

2. Background Art

Passive (i.e. not actively configurable), 2-port optical devices are used in myriad applications. Within the field of fiber-optic communications systems, for example, they are frequently used for the selection/definition of a wavelength division multiplexed (WDM) channel, the gain flattening of optical amplifiers and compensation of chromatic dispersion. These applications can be more generally classified as high-spectral resolution, low-spectral resolution and phase-only, respectively. Popular realizations of such filters take the form of autoregressive structures, such as fiber Bragg gratings and thin film filters. In both of those techniques, subtle variations in an otherwise perfectly periodic structure enable feature-rich shaping of the amplitude and/or phase of the optical transfer function.

In contrast, passive 2-port diffraction grating based filters are rarely used for purposes other than wavelength-sifting, with a given device passing only the narrow range of wavelengths in the vicinity of its spectrally sharp peak transmittance. The potential advantage of a diffraction grating based approach is that such structures are easily reproducible in mass quantities, via replication from a master stamp. However, except for a few applications involving structures which differ trivially from a standard diffraction grating, as for example a linear stretching of the grating period (a process known as chirping), the prior art is devoid of grating-based, passive 2-port filters designed to realize general-purpose, complex optical transfer functions. The present invention attempts to fill this void with the introduction of deliberate perturbations, introduced in a simple way, in the period and depth of the grooves of an otherwise standard diffraction grating. As the functions targeted by the present invention are narrow-band, in the sense that the wavelength range of interest is small compared to the average wavelength within that range, an echelle is the most appropriate grating type for comparison.

Harrison, George R. (“The Production of diffraction gratings: 11. Design of eschelle gratings and spectrographs”, J. Opt. Soc. Amer., vol. 39, 1949, p.522) is credited with the invention of the echelle grating for use as a high-spectral-resolution, non-scanning spectrometer. It is essentially similar in form and function to an ordinary diffraction grating, only its grooves are very wide and shallow, resulting in a relatively long time delay between the (isotropically) radiated copies of the input field. These structures have Littrow angles very close to 90 degrees and are commonly used to realize diffraction orders above 1000.

However, as a consequence of this extraordinary spectral resolution, the free spectral range (FSR) of the device is significantly diminished. The FSR represents the frequency range over which the spectral response repeats, and is numerically equivalent to the inverse of the observed delay between successive apertures. Hence, there is a fundamental trade-off between high spectral resolution and FSR, and consequently, it is understood that such structures, as estimators of an input optical signal's power spectral density, can be applied with arbitrarily high resolution, but at the expense of the wavelength range over which a spectrum can be resolved without aliasing. In fact, the original motivation for the development of echelle gratings was the validation of the “hyperfine” spectral structure, Zeeman effects and other optical phenomena, predicted from quantum theory, which are characterized by very sharp spectral variations occurring over a very narrow wavelength band.

Assuming all delays between successive apertures in a standard echelle grating to be precisely identical, and assuming perfectly isotropic line radiators (i.e. ignoring groove apodization), the monochromatic Fraunhofer diffraction pattern associated with such structures is an Airy function, and this pattern simply shifts as the wavelength is varied, by a proportionality constant known as the angular dispersion. Small deviations from a perfectly uniform delay between successive radiators and/or the spatial separation between radiators will result in a distortion of that Airy function. Nonetheless, whatever Fraunhofer diffraction pattern is produced at a given wavelength by the imperfect array, that pattern will simply shift linearly with increasing wavelength, with precisely the same angular dispersion as it would for a perfect echelle of the same nominal groove spacing, assuming small wavelength changes typical of an echelle-class FSR. Ranalli (U.S. Pat. No. 6,362,879) recognized the ability of deconvolving this function from the detected average intensity profiles associated with the diffraction from such imperfect echelles, via numerical post-detection signal processing. Thus, the distortion resulting from small imperfections could be compensated numerically.

Conversely, if such perturbations could be generated in a controlled manner, this could serve not only as a means of selectively shaping a monochromatic diffraction pattern, but also as a method for synthesizing a desired filter response. As is well known from diffraction theory, the Fraunhofer pattern associated with a given wavelength component of an object field (in this case, an array of isotropic radiators) represents the angular distribution of the electric field composing the object at that wavelength. If there were many wavelengths present in the object field, the Fraunhofer pattern would simply represent a superposition of the angular distributions for each associated wavelength. It is important to note, however, that for a narrow band of wavelengths, these angular distributions are essentially identical, except for a wavelength-dependent shift. Consequently, if instead of observing the entire angular distribution, the observation angle were fixed, then the spectral transmittance of the resulting 2-port optical system would be identical to the pattern associated with monochromatic Fraunhofer diffraction, with wavelength replacing diffraction angle, when scaled by the angular dispersion.

Hence, the transmission spectrum associated with a perfect echelle, illuminated at a fixed angle and observed at a fixed angle, would be an Airy function. By making controlled perturbations to the echelle period and depth, the present invention allows the specification of a structure capable of realizing any complex, narrow-band transfer function, thus enabling the mass production of many such filters, via replication from a suitably constructed master stamp. The present disclosure describes the details of this approach, which need not be limited to optical signals, but can be applied to all wave phenomena.

### SUMMARY OF THE INVENTION

Accordingly, it is an object of the present invention to provide a technique for approximating any desired narrow-band temporal impulse response, or equivalently, any desired frequency-domain transfer function (the Fourier transform of the impulse response), specified in both frequency dependent amplitude and phase, by spatially perturbing the standard fixed-period diffraction grating structure in a simple, mathematically precise manner. This technique is valid not only in optical filtering systems, but also applies to any linear physical system which is capable of supporting waves.

It is a further object to provide a means for realizing the above-mentioned technique in the optical domain, using a spatially perturbed reflection grating device, the geometry of which is specified through the proper application of the prescribed technique. The resulting device may be described as an echelle having a plurality of reflective surfaces, the size and relative positions of which establish the parameters of the corresponding transfer function. The technique may also be implemented in a guided-wave device, which is expected to be its most practical realization for applications involving passive filtering in fiber-optic communications.

It is a further object to demonstrate the utility of this technique in two vastly different optical matched-filtering scenarios, one of which involves the spectroscopic sensing of a gas, the other of which involves chromatic dispersion compensation. These examples are complementary in the sense that the former is concerned solely with the amplitude of the spectral response of the filter, while the latter is concerned solely with the phase.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a conceptual diagram of a filter configured in accordance with a preferred embodiment of the invention;

FIG. 2 is a view of three facets of an echelle surface in the special case of an ordinary diffraction grating;

FIG. 3 is a view of three facets of an echelle surface in the general case;

FIG. 4 is a three-term example of a target impulse response;

FIG. 5 is the cumulative distribution function (CDF) corresponding to the target function shown in FIG. 4;

FIG. 6 is a schematic showing how the CDF is mapped to the facet locations for the echelle corresponding to the target function specified in FIG. 4;

FIG. 7 is a graphical representation of the Raman-generated spectrum of carbon tetrachloride (CCl₄);

FIG. 8 is a graphical representation of the magnitudes of the impulse response coefficients corresponding to a filter, configured in accordance with the present invention, for detecting CCl₄;

FIG. 9 is a graphical representation of the facet delay perturbations corresponding to an echelle filter, configured in accordance with the present invention, for detecting CCl₄;

FIG. 10 is an estimate of the echelle device output, corresponding to a filter, configured in accordance with the present invention, for detecting CCl₄;

FIG. 11 is the desired wavelength-dependent phase response for the echelle filter, configured in accordance with the present invention, for correcting chromatic dispersion;

FIG. 12 is a graphical representation of the magnitudes of the impulse response coefficients corresponding to an echelle filter, configured in accordance with the present invention, for correcting chromatic dispersion;

FIG. 13 is a graphical representation of the facet delay perturbations corresponding to an echelle filter, configured in accordance with the present invention, for correcting chromatic dispersion; and

FIG. 14 is the estimated wavelength-dependent phase response for the echelle filter, configured in accordance with the present invention, for correcting chromatic dispersion.

### DETAILED DESCRIPTION OF THE PREFERRED EMBODIMENT

The present invention may be classified as a narrow-band, moving-average realization of an optical tapped-delay line (TDL) filter. As such, the device operates by transmitting a superposition of many copies of the input signal, suitably weighted and delayed. In practice, any optical realization of this filter paradigm is only approximately correct, since a true TDL filter weighs each temporal sample of an input signal by the same complex constant, independent of the spectral content of a given sample. This is not generally possible in a real device, although it tends to be a good approximation for narrow-band cases, including that of the standard diffraction grating. Because the present invention is best described using a TDL formalism, that formalism will be used to first analyze an ordinary reflection-type diffraction grating and predict the expected behavior for that special case. Following that analysis, it is a relatively simple matter to specify the filter synthesis process.

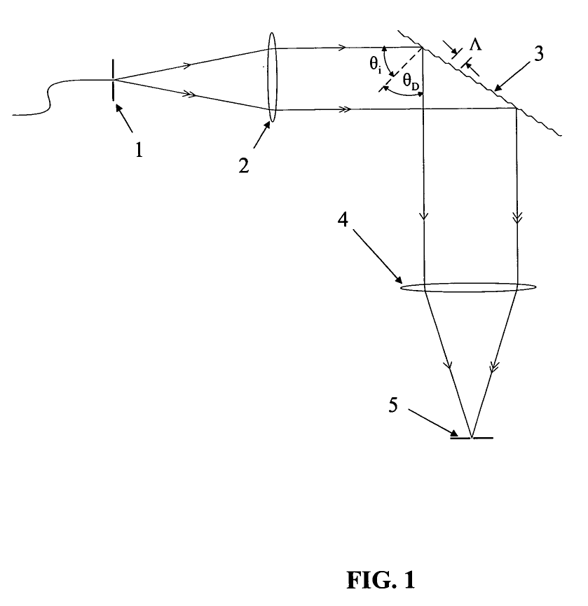

In an ordinary diffraction grating, each sample of the incident optical signal is weighted by the same constant, namely, the common reflection coefficient of each grating facet, which is ideally wavelength-independent. FIG. 1 shows a schematic for a passive, 2-port, ordinary diffraction grating based filter. The input signal is specified as E(t), representing the electric field variation over time t for a given polarization component of the input optical field. To ensure that this field is distributed spatially in an unambiguous manner, an entrance pupil 1 serves to filter all spatial modes other than the one desired. In practice, this function is often served by having the signal come in on a single-mode fiber, in which case the apodizing function is the single allowed guided mode for that fiber. An input lens 2 then collimates the field emanating from the input aperture 1 into a parallel beam, such that all wavelengths comprising the input signal E(t) are transformed by the lens 2 into plane wavefronts, incident on the grating surface 3 at a common angle of incidence, represented by the angle θᵢ. An output lens 4 then collects the components of the grating-diffracted signal which reconstruct at an angle θ_{D} with respect to the grating surface normal, into the single-mode output aperture 5.

The spacing between the grooves (i.e. the pitch) of the grating defines the sampling rate of the input signal by this periodic structure in the following manner. If A represents the grating pitch, as indicated in FIG. 1, then the sampling interval, or the delay between the arrival (at the output aperture) of signal components sampled by consecutive grooves, is defined as T=(Λ[sin θᵢ-sin θ_{D}])/c, where c is the speed of light in the incident medium. It is assumed that the numerical apertures of the spatial distributions associated with 1 and 5 are sufficiently large that the system transfer function may be estimated from the associated ray-optic picture. A detailed discussion of the assumptions leading to that condition is provided in chapter 3 of Principles of Optics, by Born and Wolf. Accordingly, the transfer function H(v) at a given frequency v for the device depicted in FIG. 1 may be estimated by summing the complex contributions over the M exposed facets of the grating surface 3.

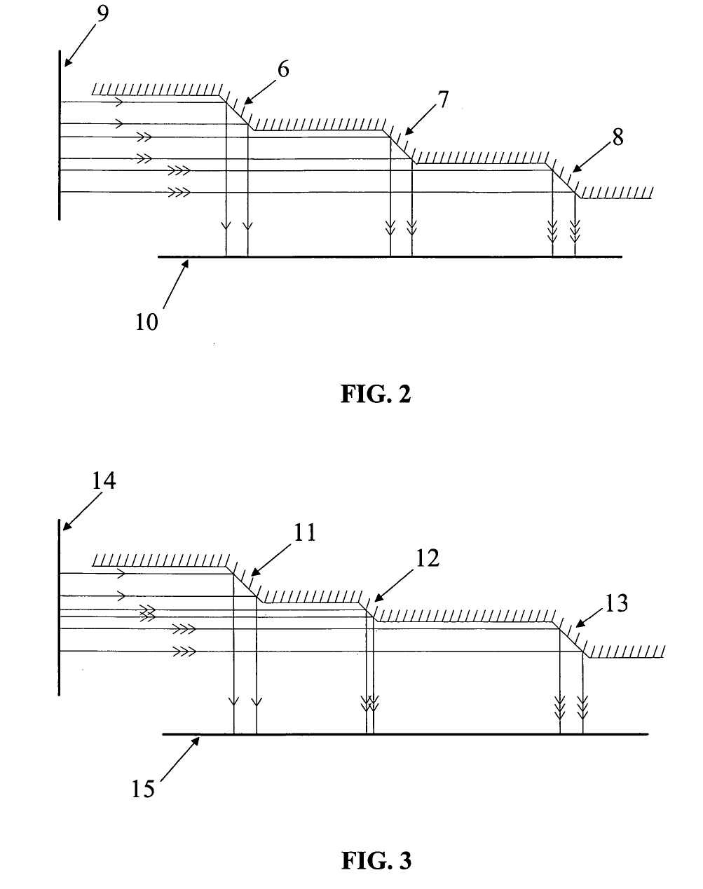

FIG. 2 shows detailed ray trajectories for three adjacent facets, identified as 6, 7 and 8. Arbitrary reference planes are indicated by 9 and 10. Without loss of generality, it may be assumed that the rays reflect specularly from each facet (i.e. the grating is blazed for a targeted diffraction angle for a prescribed center wavelength). Hence, the double-arrowhead rays reflecting from 7 take T seconds longer to get from 9 to 10 than do the single-arrowhead rays, reflecting from 6. Correspondingly, the triple-arrowhead rays reflecting from 8 take T seconds longer than do the double-arrowhead rays, or 2T seconds longer than do the single-arrowhead rays. Equivalently, it may be said that the in-air optical path lengths for ray trajectories corresponding to adjacent facets differ by cT. Accordingly, the impulse response of the system may be represented by the following expression:

$$h ( t ) = {\sum }_{m = 0}^{M - 1} {α}_{m} δ ( t - {t}_{min} - mT ) \qquad ( 1 )$$

where tₘᵢₙ represents the minimum delay from input to output (traced by the single-arrowhead paths indicated in FIG. 1), m is the groove index and αₘ is the weighting coefficient for the m'th groove. The (generally complex) values for these weighting coefficients are determined by the details of the input and output apodization functions. For the present discussion however, it is instructive to consider the simple case of a uniform illumination, resulting in the weighting coefficients being identical constants—i.e. αₘ=α. Subsequently, the transfer function H(v) is obtained by Fourier-transforming the impulse response:

$$H ( v ) = α {\sum }_{m = 0}^{M - 1} {ⅇ}^{- j2π ( {t}_{min} + mT ) v} \qquad ( 2 )$$

Taking the squared magnitude of this expression yields the expected Airy function, well known as the angular power spectral transfer function for a uniformly-illuminated, M-groove diffraction grating, multiplied by the magnitude squared of α, which essentially serves as a normalization constant:

$$S ( v ) = {\vert H ( v ) \vert}^{2} = {\vert α \vert}^{2} \frac{{sin}^{2} ( π MTv )}{{sin}^{2} ( π Tv )} \qquad ( 3 )$$

To achieve a more general transfer function than that of a uniformly-illuminated, ordinary diffraction grating, the periodic structure is perturbed, so that not only are the tap weights non-identical, but the delays themselves are tap-dependent. FIG. 3 suggests how this change is manifest in the perturbed-grating surface. The reference surfaces are now indicated by 14 and 15. Notice that now the difference between the optical path length traversed by the double-arrowhead rays (reflecting off facet 12) and that traversed by the single-arrowhead rays (reflecting off facet 11) is no longer equivalent to the difference between the optical path lengths traversed by the triple-arrowhead rays (reflecting off facet 13) and the double-arrowhead rays. The difference between any signal paths corresponding to consecutive facets, divided by c, is a small, facet-dependent delay perturbation from a constant (average) value. This average value will continue to be referred to as the sampling interval T. Thus, signal components reflecting off the m'th facet will experience (to within an arbitrary constant) a delay equivalent to tₘ=mT+Δtₘ, where Δtₘ now represents the delay perturbation for the m'th facet, or tap. Furthermore, notice that the reflection area for each facet is now different, so that under the previously-assumed, constant-illumination conditions, the tap weights would no longer be constant, but could be specified as required by the desired narrow-band impulse response (NBIR). It should be noted that the difference between consecutive delays suggested by FIG. 3 is highly exaggerated, for purposes of simplifying its conceptualization.

To specify the required surface precisely, the design begins with a consideration of the appropriate sampling interval, T. As is well known from the theory of sampled signals (e.g. Digital Control Systems, by Kuo), a consequence of sampling an input at this rate is that a linear, dispersionless system will result in a cyclic frequency response, which repeats at frequency intervals of 1/T. While it is not necessarily a requirement that the materials comprising a device which implements the present invention be dispersionless, it nonetheless serves as a guiding principle that the sampling interval T should be chosen such that 1/T (the aforementioned FSR) is at least twice the bandwidth over which we wish to specify the filter response. Once T is specified, the next parameter to be chosen is the number of facets to be illuminated. This can be estimated from the desired spectral resolution of the desired transfer function. If the desired spectral resolution in the response were W cycles/second, then the minimum number of facets required would be at least as large as the ratio of the FSR to this feature. If we call this minimum number of facets M, then M is equivalent to the ratio FSR/W, rounded up to the nearest integer.

The relative facet weights (αₘ) and associated delay perturbations (Δtₘ) are computed in the following manner. First, the NBIR is expressed as the inverse Fourier-transform of the desired transfer function, Ĥ(ν). In the sampled formalism presented thus far, this is found by specifying samples of the target function at frequencies νₙ where n is indexed from zero to M-1 :

$${\hat{h}}_{m} = {\sum }_{n = 0}^{M - 1} \hat{H} ( {v}_{n} ) {ⅇ}^{j2π {v}_{n} mT} \qquad ( 4 )$$

where ĥₘ now represents the m'th facet coefficient, which is clearly a complex number. As such, it possesses an amplitude, |ĥₘ|, and phase, φₘ. Clearly, the amplitude is mapped to the width of the m'th facet, and the phase is mapped to its exact position.

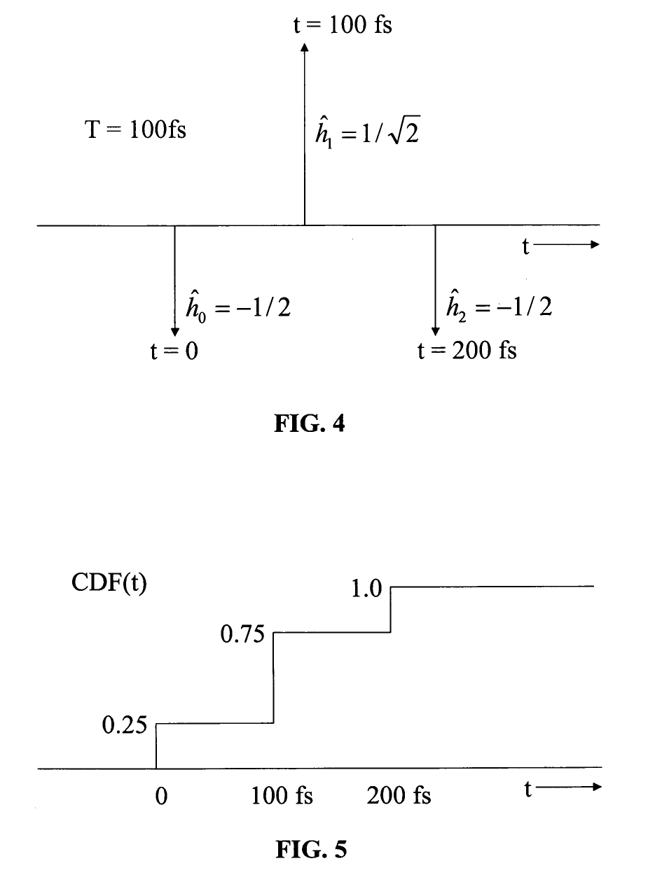

The amplitude is mapped by equating the cumulative energy distribution in the normalized impulse response to the field overlap at the echelle surface. As a trivial example, FIG. 4 shows a complex impulse response to be synthesized by a 3-facet device. The response is normalized in the sense that the squares of the amplitudes sum to unity. The sampling interval is chosen as 100 fs, or 10⁻¹³ seconds, resulting in a FSR of 13.3 GHz at a center wavelength of 632.8 nm (i.e. centered around a HeNe laser output). Notice that ĥ₀ and ĥ₂ are negative numbers, corresponding to a π radian phase shift with respect to ĥ₁. In general, of course, any phase shift (truncated to within a range from 0 to 2π radians) can be accommodated in the present invention.

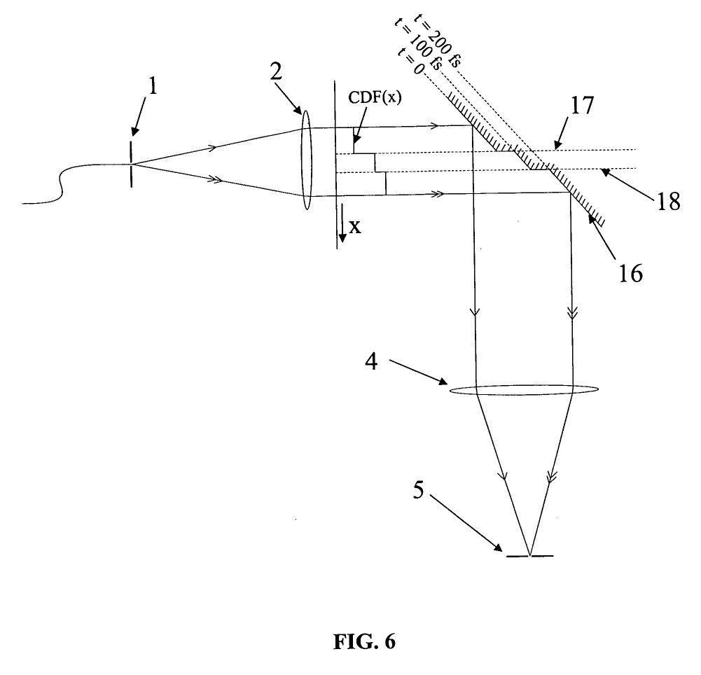

FIG. 5 shows the cumulative distribution function (CDF) corresponding to the specified impulse response. One quarter of the energy is processed at time t =0, half of the energy is processed at t =100 fs, and the remaining quarter of the energy is processed at t =200 fs. Accordingly, one quarter of the energy must be reflected by the first facet, one half by the second facet (at a delay of roughly 100 fs relative to the first facet), and the remaining quarter by the third facet (at a delay of roughly 200 fs relative to the first facet). FIG. 6 shows how this CDF is mapped to an echelle surface 16, which is nearly the final design. The CDF for the incident beam is computed, based on the intensity distribution which corresponds to the apodization function for 1. It is superimposed on the beam schematic, with the dotted lines 17 and 18 corresponding to the demarcations specified in FIG. 5 indicating the 0.75 and 1.0 marks, respectively. Thus, one-quarter of the energy in the incident beam lies above 17, and reflects off the first facet, at a relative delay of zero. Half the incident energy lies between 17 and 18, and reflects off the second facet, at a relative delay of nearly 100 fs (the correction for the exact delay is explained below). The remaining one-quarter of the energy lies below 18, and is reflected by the third facet, at a relative delay of nearly 200 fs.

As is evident for this simple example, the reflected beam is now wider than the incident beam. This anamorphic magnification is a common feature of diffraction grating-based optical systems. It will turn out to be equivalent to the ratio of the cosines of the effective angles of incidence, relative to the nominal echelle surface, for the input and output beams. For this particular example, the difference in angle between the input and output beams is 90 degrees, motivating a blaze angle of 45 degrees. Barring anomalies which may become evident upon a full vector-diffraction treatment of the problem for the particular materials and dimensions chosen, it is generally the case that the normal to the reflective facet should correspond to the difference in the Poynting vectors between the output and input beams.

Finally, the facet positions must be perturbed from the 100 fs grid suggested in FIG. 6, in order to accommodate the precise tap phase. Under the narrow-band conditions assumed in this invention, the phase shift due to small delay perturbation from a multiple of the sampling interval T is nearly independent of wavelength, at least over the relatively small wavelength range over which serves as the domain for these devices. Thus, if the center wavelength for the filter specification is λ_{c}, then the delay perturbation corresponding to that phase is

$$Δ {t}_{m} = \frac{{φ}_{m}}{\frac{2 π c}{{λ}_{c}}} \qquad ( 5 )$$

For the example associated with FIG. 6, if the center wavelength for the filter specification is 632.8 nm, then achieving a π radian phase shift amounts to perturbing the associated delays by 1.0547 fs, corresponding to an in-air path length perturbation of 0.316 microns. Thus, the final specification of the delays in FIG. 6 would be 1.05 fs for the first facet, 100 fs for the second facet, and 201.05 fs for the third, and a final description of the echelle surface 16 is complete.

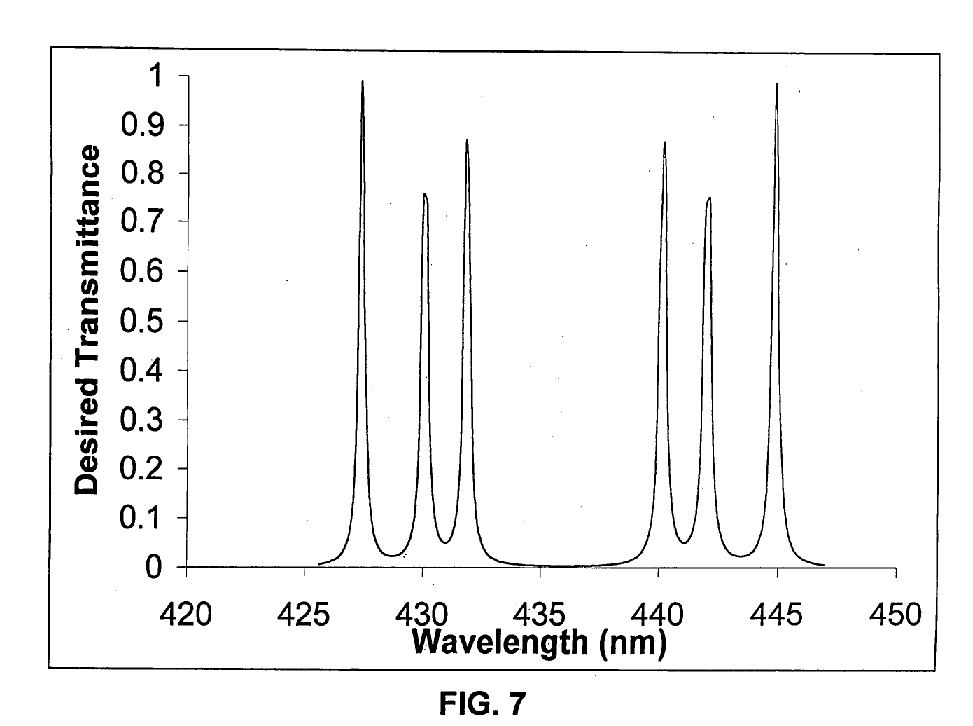

In order to render transparent any relevant design considerations of a more complex device which attempts to utilize this technique, preferred embodiments of the invention for two practical applications are now presented. The first embodiment is an optical filter for detecting the presence of the gas, carbon tetrachloride (CCl₄). An air sample can be probed optically for trace amounts of CCl₄ by impinging light of an appropriate wavelength upon the sample, and verifying the presence of the associated Raman spectrum for its interaction with CCl₄. FIG. 7 illustrates a suitable transmission spectrum for such a filter. The probing laser is assumed to be GaN (a semiconductor laser, hence convenient for on-site, portable sensing), lasing in the vicinity of 436 nm. A fraction of the laser's power is converted, via Raman scatter, into an optical emission process, the spectrum of which exhibits narrow peaks (so-called Stokes and anti-Stokes lines), symmetrically located in a narrow wavelength band about the laser's center wavelength. The standard verification procedure requires scanning the entire relevant spectral range and correlating the positions of the spectral peaks with the expected Raman response, which involves expensive, high-resolution spectroscopic analysis equipment. An inexpensive alternative to this verification process would utilize a matched filter, specifically designed to transmit wavelengths at the Raman spectral peaks, while rejecting the original pump wavelength as much as possible. The presence of the gas could then be discerned by normalizing the output of this filter with an estimate of the input power, resulting in an estimate of the fraction of the laser's energy that is Raman-converted.

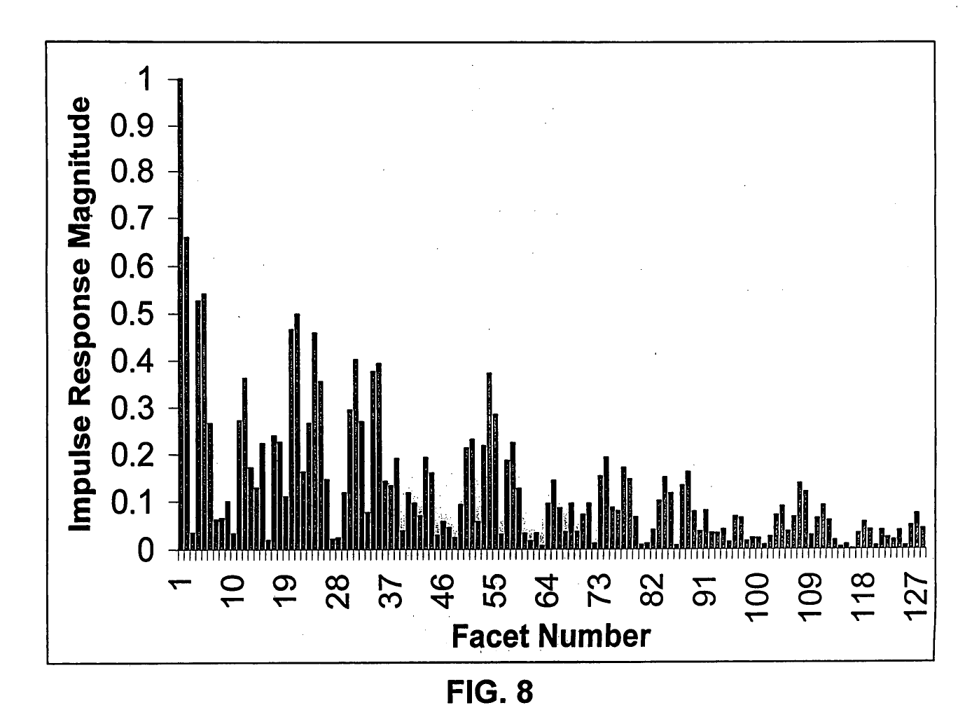

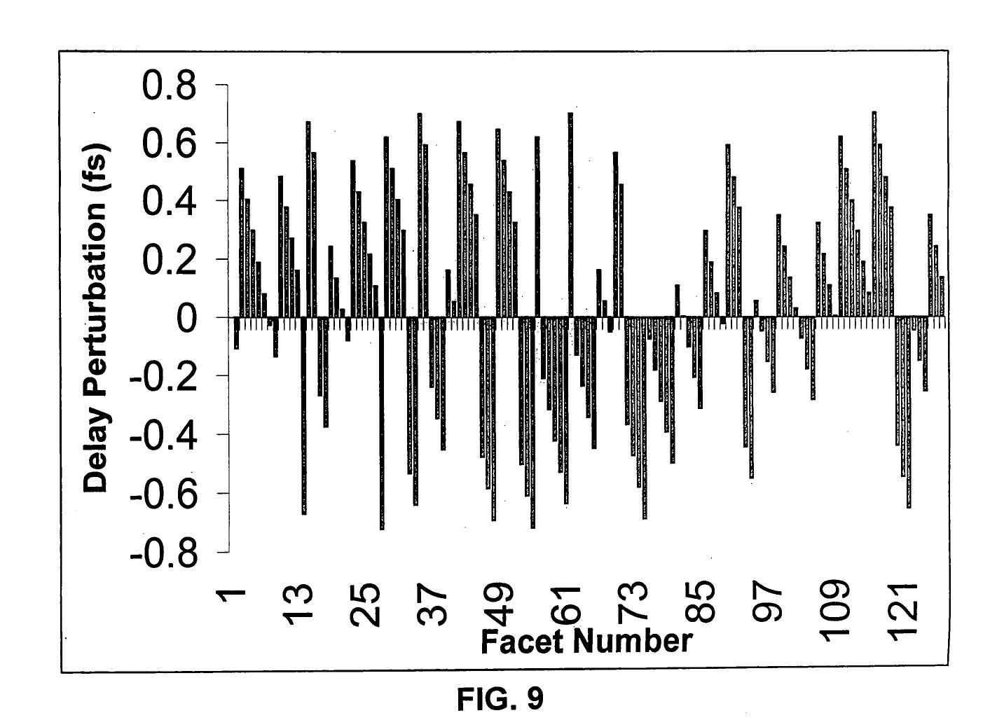

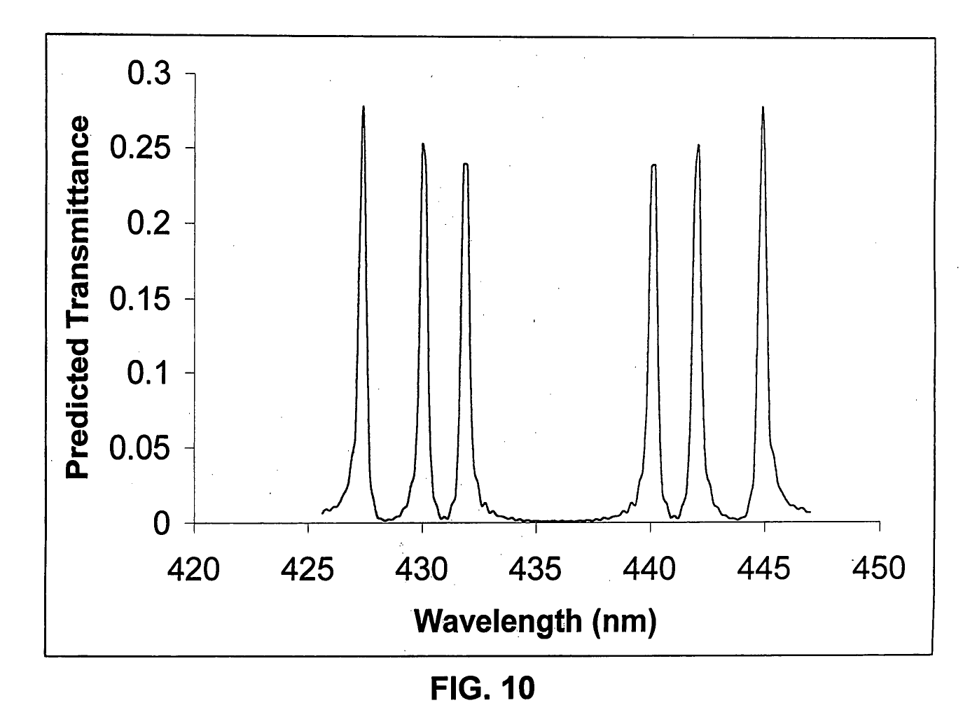

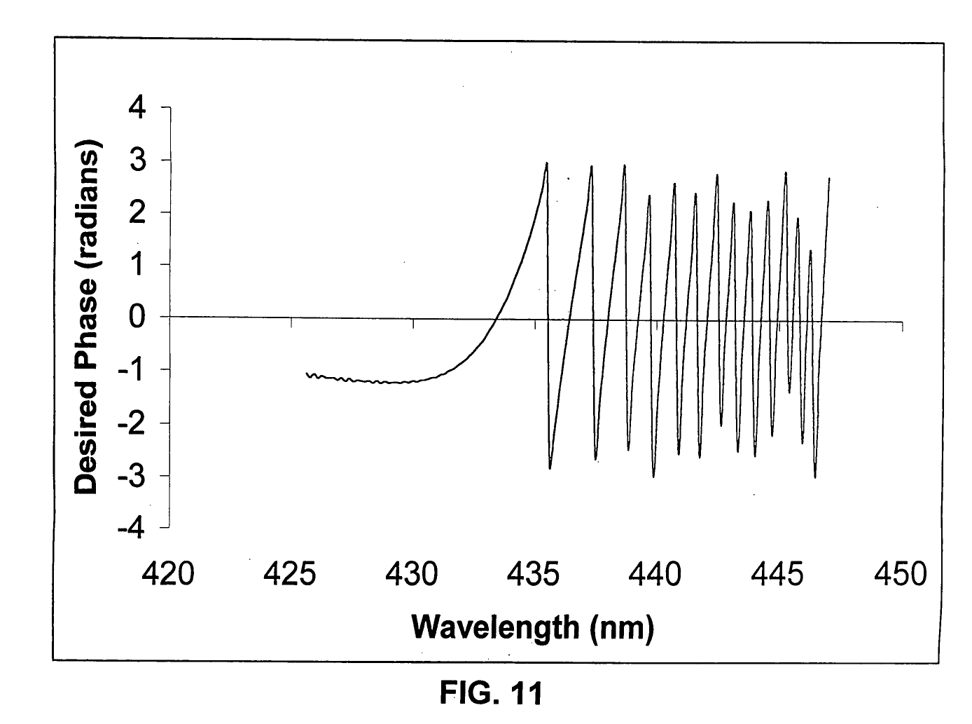

The spectrum shown in FIG. 7 was sampled at 12.97 fs/sample, corresponding to a FSR of about 49 nm. This should be sufficient, since the full width is observed to be roughly 20 nm, and so 49 nm covers comfortably more than 2 bandwidths, as prescribed above. It is desired that a filter be realized with 128 facets, yielding a spectral resolution of 49 nm/128, or 0.38 nm. Since only the spectrum is of interest for this particular application, we are free to choose the wavelength-dependent phase. We thus arbitrarily choose the phase to be constant. FIG. 8 shows the resulting distribution of facet amplitudes (i.e. the |ĥₘ|'s) for this filter. These are converted to the facet widths via the prescription outlined above. FIG. 9 shows the corresponding delay perturbations. Thus, the structure is unambiguously specified. Subsequently, a master could now be mechanically ruled, so that copies could be stamped out, in a similar manner in which diffraction gratings are replicated. To show that the resulting filter would yield the correct spectral transmittance, despite the approximate use of a delay as a wavelength-independent phase-shifting mechanism, the full (wavelength-dependent phase) model was implemented, and the resulting predicted transmittance is shown in FIG. 10. A finer (and possibly more efficient) fit to the target can be obtained by linearizing the error and correcting to second order, but already the flexibility of such a structure to accurately realize complicated spectral responses with high resolution is evident.

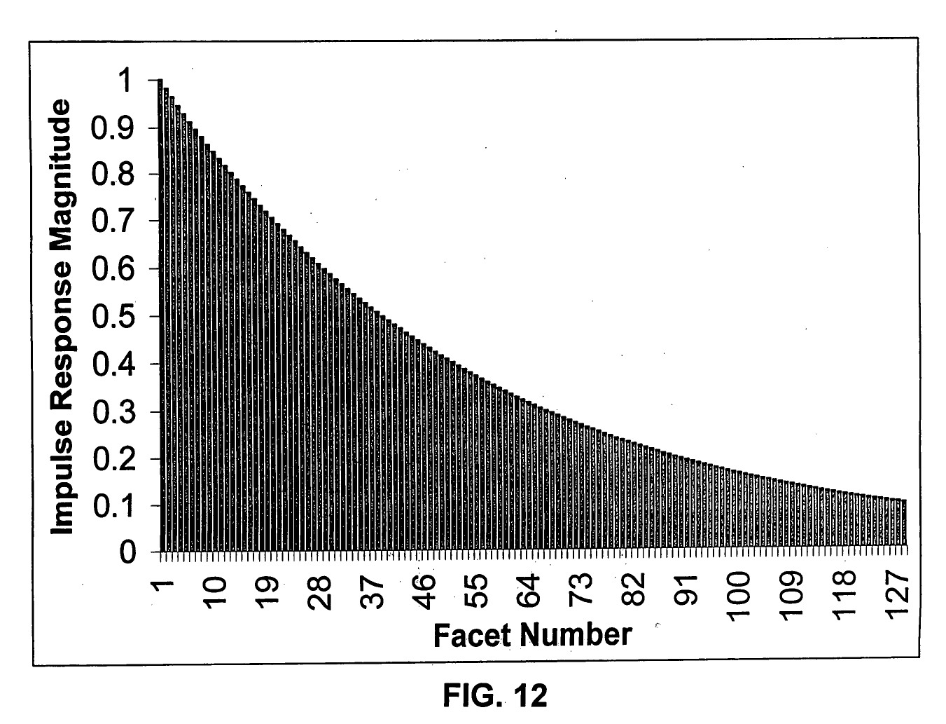

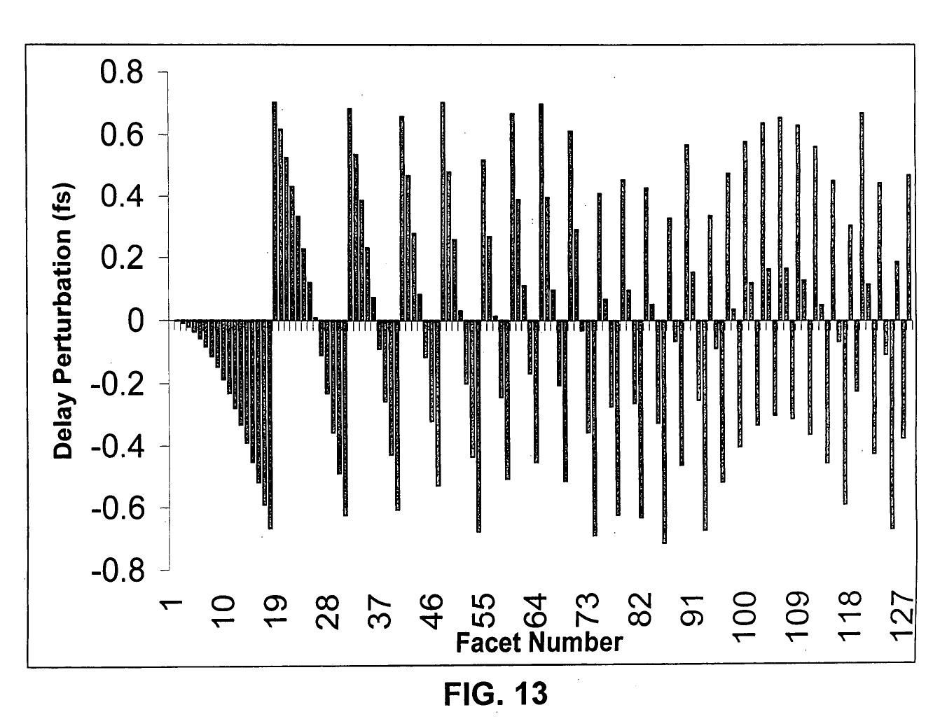

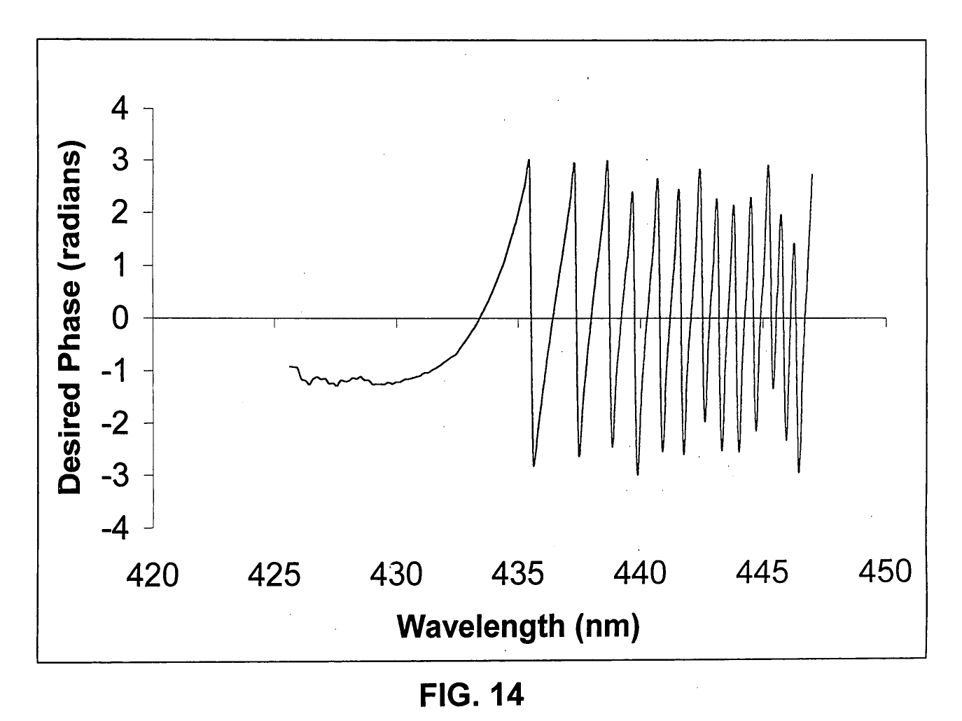

The second practical embodiment involves the correction of chromatic dispersion. In this example, it is desired that the filter implement a phase shift, which is quadratic with frequency, with a resulting desired impulse response, specified by the following equation:

$${\hat{h}}_{m} = \frac{1}{2 τ} {ⅇ}^{- \frac{\vert mT \vert}{τ}} {ⅇ}^{- jβ {m}^{2}} \qquad ( 6 )$$

where τ is a time constant (an equivalent photon lifetime), numerically specified as 700 fs, and β is a quadratic phase constant, numerically specified as 10 mRad/sample². The sampling interval, center wavelength and number of samples are the same as in the previous example. FIG. 11 shows the phase response for the ideal transfer function. Following the same procedure as in the previous example, the step and delay perturbations were obtained, and shown in FIG. 12 and FIG. 13, respectively. FIG. 12 anticipates a result commonly seen in other approaches to dispersion compensation. Namely, the grating is chirped, in the sense that the facet spacing is increasing or decreasing with wavelength. Finally, FIG. 14 shows the predicted phase response. Note the extremely close correspondence with the desired phase response (FIG. 11). In fact, the two agree to within an RMS phase error of only 36 mRad.

Having thus disclosed a preferred embodiment of the method of the invention and illustrative examples of carrying out that method to achieve optical devices, it will now be apparent to those of skill in the relevant art that the present invention has numerous and highly advantageous applications. Moreover, with the benefit of the teaching herein, various modifications and additions will now be perceived. Accordingly, the invention is not to be limited by the disclosed embodiments, but only by the appended claims and their equivalents.

I claim:

1. A quasi-periodic echelle grating structure for use in an optical device to achieve a desired narrow-band optical transfer function, which is the Fourier transform of the desired impulse response; the structure comprising:
a plurality of contiguous reflective grating facets, the nominal spacing of which corresponds to a desired free spectral range, and the number of said facets being selected based upon the desired spectral resolution of said transfer function;
each said facet having a size corresponding to an amplitude of said impulse response coefficient at a selected delay; and
each said facet having a position corresponding to a phase of said impulse response coefficient at a selected delay.

2. The echelle grating structure recited in claim 1 wherein said structure is replicated from a master.

3. The echelle grating structure recited in claim 1 wherein each said facet is coated for increased reflectivity.

4. An optical system for realizing a selected transfer function for narrow-band incident optical signals; the system comprising:
entrance and exit apertures which are spatially single-mode over a wavelength range of interest;
an echelle structure having a selected number of reflective facets, the nominal spacing, the number of facets, the size of each facet and the position of each facet being selected to approximate said selected transfer function; and
at least one collimator for collimating said optical signals onto said echelle structure.

5. The optical system recited in claim 4 wherein at least one of said entrance and exit apertures comprises a single-mode optical fiber.

6. The optical system recited in claim 4 further comprising a single-mode slab waveguide which confines said optical signals in at least one direction and wherein said echelle structure is formed in an edge of said slab waveguide.

7. An optical filter having a selected arbitrary narrow-band impulse response; the filter comprising:
entrance and exit apertures which are spatially single mode over the selected filter bandwidth;
an echelle structure having a selected number of reflective facets, the nominal spacing, the number of facets and their respective sizes and positions being selected to approximate said selected transfer function; and
at least one collimator for collimating light signals onto said echelle structure.

8. The optical filter recited in claim 7 wherein at least one of said entrance and exit apertures comprises a single-mode optical fiber.

9. The optical filter recited in claim 7 further comprising a single-mode slab waveguide which confines said optical signals in at least one direction and wherein said echelle structure is formed in an edge of said slab waveguide.

10. A method of fabricating an echelle grating structure for use in an optical device to achieve a desired narrow-band optical transfer function; the method comprising the steps of:
a) determining the nominal grating spacing of said echelle structure based on the free spectral range FSR of the desired narrow-band optical transfer function;
b) determining the minimum number of echelle facets M based upon the free spectral range FSR of the optical device and the desired spectral resolution W of the response of the optical device, where
$$M = \frac{FSR}{W}$$
rounded up to the nearest integer;
c) expressing the desired optical impulse response as the inverse Fourier-transform of the desired optical transfer function;
d) setting the size of each said facet based upon the amplitude of the corresponding impulse response coefficient; and
e) setting the precise position of each said facet, as a perturbation from the nominal grating spacing, based upon the phase of the corresponding impulse response coefficient.
